(19) United States
(12) Patent Application Publication
(10) Pub. No.: US 2014/0279702 A1
(43) Pub. Date: Sep. 18, 2014

(54) SOCIAL IMPACT INVESTMENT INDEX APPARATUSES, METHODS, AND SYSTEMS

(71) Applicant: Nicole Douillet, Brooklyn, NY (US)

(72) Inventor: Nicole Douillet, Brooklyn, NY (US)

(21) Appl. No.: 14/215,847

(22) Filed: Mar. 17, 2014

Related U.S. Application Data
(60) Provisional application No. 61/892,565, filed on Oct. 18, 2013.
(60) Provisional application No. 61/798,604, filed on Mar. 15, 2013.

(51) Int. Cl. G06Q 40/06

(52) U.S. Cl. CPC G06Q 40/06
USPC 705/36 R

(57) ABSTRACT

Apparatuses, methods, and systems for calculating an investable index, including determining a non-financial impact metric associated with each company included in a predetermined group of publicly traded companies, comparing each one of the non-financial impact metrics to a predetermined threshold, creating a notional portfolio that includes only the companies in the predetermined group whose non-financial impact score meets the predetermined threshold, and calculating an index value based on at least a publicly available share price and the non-financial impact metric, for each company in the notional portfolio.

### CROSS REFERENCE TO RELATED APPLICATIONS

This application claims priority to U.S. Provisional Patent Application No. 61/798,604, filed Mar. 15, 2013, and to U.S. Provisional Patent Application No. 61/892,565, filed Oct. 18, 2013. These applications are herein incorporated by reference in their entirety.

### FIELD

The present invention is directed generally to methods and systems for creating financial indices and financial instruments. More particularly, the invention is directed to SOCIAL IMPACT INVESTMENT INDEX APPARATUSES, METHODS, AND SYSTEMS (hereinafter SI).

### BACKGROUND

Increasingly, investors are looking at more than financial performance data when determining where to invest their money; they are also considering how their investments will impact a particular issue of interest to them or how their investments will affect society as a whole. By considering both financial metrics and non-financial metrics, so-called impact investors are able to put their capital to work in a way that earns a return while at the same time contributing to the greater good.

### BRIEF SUMMARY

A processor-implemented method for calculating an investable index is disclosed. The method includes determining a non-financial impact metric associated with each company included in a predetermined group of publicly traded companies, comparing each one of the non-financial impact metrics to a predetermined threshold, creating a notional portfolio that includes only the companies in the predetermined group whose non-financial metric meets the predetermined threshold, and calculating an index value based on at least a publicly available share price and the non-financial impact metric, for each company in the notional portfolio.

A system for calculating an investable index that includes a non-financial impact metric component is also disclosed. The system includes a server having a processor and a memory and being programmable to interface with a database, and an index calculator interfacing with the server. The index calculator is programmable to: determine a non-financial impact metric associated with each company included in a predetermined group of publicly traded companies, compare each one of the non-financial impact metrics to a predetermined threshold, create a notional portfolio that includes only the companies in the predetermined group whose non-financial metric meets the predetermined threshold, and calculate an index value based on at least a publicly available share price and the non-financial impact metric, for each company in the notional portfolio.

A processor-implemented method for generating a financial instrument is also disclosed. The method includes generating at least one financial instrument having an instrument value that depends on an index value for an index that includes a non-financial impact metric component. The index value is calculated by determining a non-financial impact metric associated with each company included in a predetermined group of publicly traded companies, comparing each one of the non-financial impact metrics to a predetermined threshold, creating a notional portfolio that includes only the companies in the predetermined group whose non-financial metric meets the predetermined threshold, and calculating an index value, using the processor, based on at least a publicly available share price and the non-financial impact metric, for each company in the notional portfolio.

A processor-implemented method for calculating a Lesbian, Gay, Bisexual, and Transgender (LGBT) equality index is also disclosed. The method includes determining an LGBT equality score for each company included in a predetermined group of publicly traded companies, wherein the equality score is derived from the policies and practices of the company in relation to LGBT rights, comparing the LGBT equality score for each company to a predetermined threshold, creating a notional portfolio that includes only the companies in the predetermined group whose LGBT equality score meets the predetermined threshold; and calculating an LGBT equality index value based on at least a share price and the LGBT equality score, for each company in the notional portfolio.

Also disclosed is a tangible, non-transitory processor-readable physical medium storing processor-generated instructions to: determine a non-financial impact metric associated with each company included in a predetermined group of publicly traded companies; compare each one of the non-financial impact metrics to a predetermined threshold; create a notional portfolio that includes only the companies in the predetermined group whose non-financial metric meets the predetermined threshold; and calculate an index value, based on at least a publicly available share price and the non-financial impact metric, for each company in the notional portfolio.

### BRIEF DESCRIPTION OF THE DRAWINGS

The accompanying drawings illustrate various non-limiting, exemplary, inventive aspects in accordance with the present disclosure:

FIG. 1 shows a schematic illustration of data flows between SI components and affiliated entities in one embodiment of SI operation;

FIG. 2 shows aspects of SI architecture in block-diagram form and data flow between and among SI components in one embodiment of SI operation;

FIG. 3 shows an exemplary logic flow in one embodiment of SI operation;

FIG. 4 shows an exemplary logic flow in one aspect of SI operation; and

FIG. 5 is a block diagram illustrating embodiments of an exemplary SI controller.

### DETAILED DESCRIPTION

### SI

This disclosure describes social impact investing index apparatuses, methods, and systems (SI) as well as associated financial products. Depending on the particular needs and characteristics of SI users and their systems, various embodiments of the SI may be implemented that enable a great deal of flexibility and customization.

In one embodiment, the SI may be used to create a rule-based algorithmic index that includes an impact screening component to determine whether a particular security should be included in the index. In one implementation, the impact screening component may also determine the weight assigned to a particular security within the index. For example, the impact screening component may take into account any appropriate metric when deciding whether a company should be included as part of the index, including non-financial metrics. These non-financial metrics may relate to a company's mission, operational model and location, the company's products and services and target markets, the company's policies, employees, and environmental impact, and the performance and reach of the company's products or services. The impact screening may also be sector specific or issue specific, relating to a company's mission, operational model, policies, employees, or performance in any suitable sector or in relation to a specific issue that may be important to investors. For example, the impact screening component may evaluate metrics relating to a company's policies or track record regarding such issues as healthcare, education, sustainability, equality, health, the environment, or any other issue that an investor may deem important.

Although this disclosure includes examples of indices and investment products that take into account a company's policies and performance regarding Lesbian, Gay, Bisexual, and Transgendered (LGBT) equality, it should be understood that the scope of this disclosure is not limited to this particular embodiment. The SI may incorporate any suitable impact screening component based on any suitable non-financial metric.

FIG. 1 shows a schematic illustration of data flows between SI components and affiliated entities in one embodiment of SI operation. The SI may, in one implementation, comprise an entity including one or more SI servers 101, including one or more processors and memory devices. The servers 101 may implement SI functionality and may be communicatively coupled to one or more SI databases (“DBs”) 105 configured to store SI data. The SI server 101 may be further coupled by a communication network 100 to one or more market data sources 115, such as one or more market data feeds (e.g., Bloomberg's PhatPipe, Dun & Bradstreet, Reuter's Tib, Triarch, and the like) to draw financial data used in the generation and maintenance of SI indices. A wide variety of different data may be drawn from data sources 115, such as, but not limited to: current and historical prices of one or more underlying instruments, indices, portfolios, or other assets, current and historical prices for put and call options on such underlying assets, and the like.

The SI may process received market data to generate index values or to determine allocations of funds underlying indices to various investments. In an implementation where the instruments underlying an SI index are to be actually obtained, orders for such investments at the determined levels may be placed by the SI with one or more cash market exchanges 120 or the like, with options market exchanges 125 or the like, or with other suitable outlets, including one or both of primary and secondary markets. In another implementation, indices may be based on portfolios that are notional, simulated, synthetic, and the like. In such an implementation, orders may still be placed by the SI with one or more cash market 120 or options market 125 exchanges or the like, or with other suitable outlets to generate financial instruments or to initiate a transaction involving financial instruments based on SI-generated indices.

Index values associated with the portfolio of investments, real or synthetic, that are generated or administered by the SI server 101 may be stored in the SI database 105 for future retrieval, display, report generation, updating, and the like. In one implementation, the SI may further provide index values via communication network 100 for publication 130, such as to a website, to a market data resource, to a ticker, as a report, and the like. The SI may further be configured and/or programmed to generate one or more financial instruments with values linked to the value of one or more SI generated indices. Such instruments may include, but are not limited to, equities, debts, derivatives, notes (e.g., structured notes), stocks, preferred shares, bonds, treasuries, debentures, options, futures, swaps, rights, warrants, commodities, currencies, funds, long positions, short positions, Exchange Traded Funds (ETFs), Exchange Traded Notes (ETNs), insurance and risk transfer agreements, annuities, and other assets or investment interests. SI-generated instruments may then be made available for purchase in one or more index products markets 135.

FIG. 2 shows aspects of SI architecture in block-diagram form as well as data flow between and among SI components in one embodiment of SI operation. An SI system 201 may include any number of operational modules and/or data stores configured to carry out SI features and/or functionality. These operational modules and data stores may run on the one or more servers 101, or may run on one or more other servers with one or more processors and memory devices that interface with servers 101. An SI controller 205 may serve a central role in some embodiments of SI operation, serving to orchestrate the reception, generation and distribution of data and/or instructions to, from, and between SI modules and to allow further analysis of data generated during SI operation. The SI controller 205 may be coupled to one or more operational modules configured to and/or programmable to implement various features associated with embodiments of SI operation.

In one implementation, the SI controller 205 may be coupled to a market interface 210 configured to query and/or draw market data from one or more market data sources, place market orders or otherwise effectuate market transactions, receive confirmations of requested instrument transaction fulfillment, and perform other suitable functions.

In one implementation, the SI controller 205 may further be coupled to an index/product output interface 215, which may be configured to publish index values; generate or request generation of reports containing index values and/or the values of associated financial products; generate financial products with values linked to SI generated index values; provide SI financial products for sale on one or more markets or exchanges; and the like. In one implementation, the SI controller 205 may further be coupled to an administrator user interface 220 configured to provide an interface through which an administrator can monitor and interact with SI system settings and portfolio allocations, manage data, and the like. For example, in one implementation, an SI administrator may interface with the SI system via the administrator user interface to adjust the values of index calculation or publication times and other parameters associated with the index, as may be needed or desired within a given application of the SI.

In one implementation, the SI controller 205 may further be coupled to an index calculator module 230 configured to calculate official index values. In one implementation, the index value may be calculated on a daily basis, such as at the end of each U.S. trading day. However, index calculator module 230 may also be configured to calculate an official index value at any other suitable interval.

The index calculator 230 may also be configured to track and monitor values of components of one or more underlying real or simulated SI portfolios and to calculate index values based on the value of these components. In one implementation, the SI controller 205 may further be coupled to a portfolio manager module 235 configured to manage one or more portfolios of financial instruments underlying one or more SI indices. Such portfolios may, in various implementations, comprise actual investments or be notional, simulated or synthetic portfolios with values tied to specified investments. In one implementation, the portfolio manager module may be configured to administer a portfolio underlying the SI index comprising positions on a plurality of options on one or more underlying stocks, bonds, debts and/or debentures, currencies, commodities, real properties, options, indices, portfolios, and like assets.

In one implementation, the SI controller 205 may further be coupled to an index product marketer module 24o configured to generate, market, manage, and/or the like financial products and/or instruments with values tied to one or more SI indices. In various implementations, the index product marketer module may be configured to generate and manage any of a wide variety of different financial products, such as, but not limited to: equities, debts, derivatives, notes (e.g., structured notes), stocks, preferred shares, bonds, treasuries, debentures, options, futures, swaps, rights, warrants, commodities, currencies, funds, long and/or short positions, ETFs, ETNs, insurance and/or risk transfer agreements, annuities, and/or other assets or investment interests. In one implementation, the index product marketer module may initiate the formation of a corporation, special purpose entity, fund, and/or the like entity which owns a portfolio underlying an SI index and which issues shares with values tied to that index.

In one implementation, the SI controller 205 may further be coupled to one or more databases 245 configured to store a variety of data associated with SI operation in various embodiments. For example, in one implementation, the SI database may include tables for storing information associated with current and/or historical SI index values, underlying portfolios and/or portfolio elements, SI index linked financial products, market data, transaction orders, transaction histories, and/or the like. Further detail surrounding such tables is provided below.

FIG. 3 illustrates logic flow of an exemplary embodiment of a process for determining the composition and value of an SI index. As shown in FIG. 3 at 300, SI system 201 may begin with a predetermined universe of companies from which to select the companies to be included in the SI index. In one exemplary embodiment, companies may be chosen from among those that have already been included in a market index such as the Standard & Poor's (S&P) 1500, the S&P 500, S&P Midcap, S&P Smallcap, Nasdaq, New York Stock Exchange (NYSE), or any other suitable index. Selecting from a universe of securities that are already part of an established index allows the SI index to incorporate liquidity, domiciliation, viability, and float metrics.

At 302, SI system 201 may determine or calculate an impact metric for each of the companies within the predetermined universe. In one implementation, the impact metric may be a non-financial metric relating to at least one of a company's mission, operational model and location, the company's products and services and target markets, the company's policies, employees, and environmental impact, and the performance and reach of the company's products or services. The impact metric may also be sector specific or issue specific, relating to at least one of a company's mission, operational model, policies, employees, or performance in any suitable sector or in relation to a specific issue, such as LGBT equality, healthcare, education, sustainability, health, environmental impact, and any other suitable issue.

The impact metric may be calculated by SI system 201 or it may be retrieved from an outside source or data feed. At 304, SI system 201 determines whether a given company meets the requirements for inclusion in the SI index based on the impact metric calculated for that company. For example, a company's rating on the Corporate Equality Index, as determined by the Human Rights Campaign Foundation (www.hrc.org), may serve as an impact metric in determining whether that company will be included in the SI index.

For example, as shown in FIG. 3 at 304, if a company's impact metric does not meet a predetermined threshold, that company may be excluded from the SI index, as shown at 306. On the other hand, if the impact metric of the company meets the predetermined threshold, the company may be included in the SI index, as shown at 308. This process of determining or calculating an impact metric and then determining whether a company meets predetermined requirements is performed for each of the companies within the predetermined universe of companies.

After SI system 201 has determined which companies to include in the SI index, SI system 201 may then calculate an index value, as shown at 310, for the SI index. In one exemplary embodiment, the SI index is float weighted, meaning that the component securities in the index are weighted by the relative capitalization of only those shares that are available to the public for trading, rather than the total shares outstanding. In one exemplary embodiment, the non-financial impact metric may be used as a secondary weighting, with the resulting weight for a given security in the index being the company's float-adjusted market cap multiplied by the previously determined non-financial impact metric for the company. Other methods of calculating the index may also be used, including equal weighting, market-cap weighting, and price weighting.

In one implementation, the SI index may be reconstituted periodically. For example, there may be one annual reconstitution, which may take place on a predetermined date. The reconstitution of the SI index may be based on updated impact metrics. The frequency of the reconstitution of the SI index may also be determined by how frequently the impact metric is updated. For example, in one implementation, the impact metric may be based on the results of a survey, which are compiled and published only once a year. Other impact metrics may be calculated or determined quarterly, monthly, weekly, daily, in real-time, or during any other suitable interval.

In one implementation, the SI index may also be rebalanced periodically to account for shares outstanding, float changes, adjustments to the impact metric, or for other suitable reasons. In some implementations, a cap at a maximum weight for a given security included in the index may be applied at the time of rebalance or at any other suitable time. As shown in FIG. 3 at 312, SI system 201 may determine whether the end of a rebalance period has arrived. If the end of the rebalanced period has not arrived, SI system may determine whether a new impact metric is available, as shown at 314. If no new metric is available, the process reverts to 310 where the index value is recalculated. If a new metric is available, that new metric may be determined or calculated for each company in the universe of companies so that an updated index value may be calculated.

As shown in FIG. 3 at 316, if the end of the rebalance period has arrived, SI system may rebalance index components. SI system may then check for the availability of a new impact metric at 318, and either calculate the index value using the current impact metric if no new impact metric is available, or determine a new impact metric for each company in the universe of companies when a new impact metric is available, so that the new impact metric can be incorporated into the calculation of the index value.

In one implementation, the SI index may measure the value of a notional investment in a strategy that uses variously weighted long positions in a reference asset, such as a stock index, with the individual weights determined on a periodic basis by reference to a float-adjusted market capitalization multiplied by an impact score or metric for each of the companies included in the index.

FIG. 4 is a logic flow diagram illustrating one exemplary process that SI system 201 may use to calculate a value for the SI index, as shown at 310 of FIG. 3. As shown in FIG. 4, at 400, SI system 201 may calculate an investable weight factor (IWF) for each company that has been included in the SI index.

In one implementation, the investable weight factor IWFₘ for each of the companies included in the index may be calculated by dividing the total available float shares for the company m by the total number of shares outstanding for the company, as shown below:

$$I W {F}_{m} = \frac{Available Float {Shares}_{m}}{Total Shares {Outstanding}_{m}}$$

As used in this disclosure, company m refers to one of the total number of companies n that are to be included in the SI index, based on meeting the required threshold for the chosen impact metric. In one implementation, the available float shares for a given company m are those shares that are available to the public for trading and may be determined by taking the total outstanding shares for a company and subtracting any restricted stock, such as stock held by insiders that cannot be publicly traded. As shown in FIG. 4 at 402, this calculation is repeated for each company included in the index. Once an investable weight factor has been calculated for each company, SI system 201 may then calculate the shares of each company to be included in the index, as shown at 404 of FIG. 4.

In one implementation, the number of shares for each company in the index may be calculated by multiplying the market cap of the company by an investable weight factor for the company and by an impact metric for the company, as shown in the equation below:

Sharesₘ=Market Capₘ×IWFₘ×(IMₘ)

where Sharesₘ is the number of shares of stock for each company m included in the SI index, Market Capₘ is the market capitalization for the company m, IWFₘ is an investable weight factor for the company m, and IMₘ is an impact metric for the company m. As shown in FIG. 4 at 406, this calculation is repeated for each company included in the index.

As shown in FIG. 4 at 408, a weight for each company included in the SI index may then be calculated. In one implementation, this individual or constituent weight for each company included in the index may be calculated by dividing the total number of shares outstanding for a given company by the sum of the total number of shares outstanding for all of the companies included in the index, as represented by the following equation:

$${W}_{m} = \frac{{Shares}_{m}}{{\sum }_{m = 1}^{n} {Shares}_{m}}$$

where Wₘ is the constituent weight for a given company m, Sharesₘ is the number of shares of stock for each company m, and n is the total number of companies included in the SI index. As shown in FIG. 4 at 41o, this calculation may be repeated for each company included in the SI index.

As shown in FIG. 4 at 412, the notional number of shares for each company included in the SI index may then be calculated. In one implementation, the notional number of shares of company m may be determined using the following equation:

$${SS}_{mr} = {V}_{r} \times \frac{{W}_{mr}}{{SL}_{mr}}$$

where Vᵣ is the index value on the most recent rebalance date r, Wₘᵣ is the weight for company m on the most recent rebalance date r; and SLₘᵣ is the price of a share of company m on the most recent rebalance date r. This calculation may be repeated for each company included in the SI index.

In one implementation, the SI index may be rebalanced periodically so that hypothetical positions in the notional portfolio will reflect the weightings calculated on the rebalance date. In one implementation, on the rebalance date, each share position notionally held in the notional portfolio may be adjusted to reflect the constituent weightings determined pursuant to the process described above.

In one implementation, a divisor may be used to adjust the value of the SI index for any event that necessitates such an adjustment. For example a divisor may be used to adjust the index value when there is an event occurrence, such as a constituent change in the index, i.e., adding a company to the universe of companies or dropping a company from the universe of companies from which the index is drawn; or a corporate event or action by one or more of the companies included in the index. For example, an adjustment to the index may be needed when there is a change in the total shares outstanding, a spin-off, a change in the investable weight factor, a rights offering, a stock split, a special or extraordinary dividend, or a merger or acquisition involving one of the companies that forms a part of the index.

A divisor adjustment may be necessary for a constituent change, that is, if any constituent company is dropped from or added to the universe of companies, such as the S&P 1500 index, the SI system 201 may adjust the weights of all shares remaining in the SI index so that the weights of the remaining shares, relative to each other, will be unchanged. A divisor adjustment may also be necessary for a change in the total shares outstanding (such as a secondary issuance, share repurchase or buy back, or any other action or event that results in a change in the total shares outstanding) for any one of the companies included in the index.

A spin-off will generally decrease the market cap of the shares of the company effecting the spin-off, which may require a divisor adjustment. A change to the investable weight factor as described above may also require an adjustment of the divisor. An increase in a shares' IWF may increase the index value, while a decrease in a shares' IWF may have the opposite effect. The divisor may be adjusted in this case to negate such an effect and maintain the index value at a stable level.

A rights offering may result in a new market cap for the relevant shares, which may require a divisor adjustment. In addition, a declaration of a special or extraordinary dividend by a company included in the index may also require a divisor adjustment. For example, after the close of trading on the index calculation day immediately preceding the relevant dividend date, SI system 201 may reduce the price of the relevant shares by the per share special dividend amount.

A merger or acquisition may also require a divisor adjustment. If both companies involved in the merger are in the SI index, the index may reflect the procedure used by the S&P Capitalization Weighted Indices for adjustment to total shares outstanding and investable weight factor. In one implementation, the impact metric may be the lower of the two impact factors for the two companies. If only one company involved in the merger is in the SI index and is the target (i.e., acquired) company, in one implementation, its shares may be deleted from the SI index, which might also require a divisor adjustment. If the only index constituent involved in the merger is the acquirer, in one implementation, the SI index may reflect the adjustments to the total shares outstanding and investable weight factor, and the impact metric would not change until the next reconstitution date for the SI index.

In one exemplary embodiment, SI system 201 may adjust the divisor after closing time on a relevant exchange on the day the event or action is deemed to have occurred. After such closing time, the event or action may be reflected by adjusting the index divisor to keep the index value constant from such closing time to the next opening of trading on the relevant exchange.

As shown in FIG. 4 at 414, once the notional shares for each company to be included in the SI index have been calculated, SI system 201 may determine whether an event has occurred that would necessitate calculation of a new divisor. If an event has occurred, a new value for a divisor may be calculated, as shown at 416 in FIG. 4. If there is no event occurrence, SI system 201 may then calculate a new value for the SI index at 418.

In one implementation, SI system 201 may calculate the divisor used to adjust the index value when needed using the following formula:

$${D}_{ti , after} = {D}_{ti , before} \times \frac{{\sum }_{m = 1}^{n} {SS}_{mr , after} \times {SL}_{mti , after}}{{\sum }_{m = 1}^{n} {SS}_{mr , before} \times {SL}_{mti , before}}$$

Where D_{ti, after} is the divisor on the index calculation day t at time i, right after an event takes effect, D_{ti, before} is the divisor on the index calculation day t at a time i, right before the event takes effect, SL_{mti, after} is the price of a share of company m on the index calculation day t at time i, right before the event takes effect; SSₘᵣ, after is the notional number of shares of company m, as determined by the most recent rebalance date r right after an event takes effect; and SS_{mr, before} is the notional number of shares of company m as of the most recent rebalance date r right before an event takes effect. In one implementation, the initial value of the divisor on the start date of the SI index may be equal to 1.

Once a divisor has been calculated, or if there is no need to calculate a new divisor, SI system 201 may calculate a current index value for the SI index using the current stock price for each company in the index, the previously calculated notional number of shares, and the previously calculated divisor. In one implementation, SI system 201 may calculate a current index value for SI index, as shown at 418 in FIG. 4, using the following equation:

$${V}_{ti} = {\sum }_{m = 1}^{n} \frac{{SS}_{mr} \times {SL}_{mti}}{{D}_{ti}}$$

where Vₜᵢ is the value of the index on an index calculation day t at a time i, SLₘₜᵢ the price of a share of company m on the index calculation day t at time i; SSₘᵣ is the notional number of shares of company m, as of the most recent rebalance date r, as described above; and Dₜᵢ is a divisor on the index calculation day t at time i, as described above. In one implementation, the initial value of the index on the start date may be equal to 100.

In one implementation, SI system 201 may determine the composition of an SI index using Corporate Equality Index (CEI) ratings published by the Human Rights Campaign Foundation as the basis for the impact metric.

The CEI is a national benchmarking tool on corporate policies and practices related to Lesbian, Gay, Bisexual and Transgender (LGBT) equal rights. The CEI calculates a CEI score for a company based on that company's responses provided to the Human Rights Campaign Foundation through a survey. Each company is rated based on its responses to the CEI survey, which should be accurate to the best of the company's ability, requiring education and understanding by benefits, human resources, legal, and other professionals. Supporting documentation for certain criteria may also be required. The criteria that may be considered when determining a company's CEI score include, but are not limited to: 1) equal employment opportunity policies, 2) employment benefits, 3) organizational LGBT competency, 4) public engagement, and 5) responsible citizenship. For example, companies may be rated on a scale from 0 to 100, with a certain number of points awarded for meeting each criterion.

In one exemplary embodiment, the SI index determined using the CEI score as an impact metric may be an LGBT Equality Index. In one implementation, companies to be included in the LGBT Equality Index are chosen from among those listed in the S&P 1500, although any other suitable universe of companies may also be used. Using an established index such as the S&P 1500 as a starting point incorporates liquidity, domiciliation, viability, and float metrics into the LGBT Equality Index.

In one implementation, to be included in the LGBT Equality Index, a company must have a CEI score of 80 or above. The index may be float weighted, using S&P data for shares outstanding, adjusted by the S&P Investable Weight Factor. The LGBT Equality Index may then use the CEI score as a secondary weighting. In one implementation, the secondary weighting may be calculated by dividing the CEI score by 100. For example, a CEI score of 80 would result in an additional weight of 0.8.

In one implementation, the number of shares for each company in the LGBT Equality Index may be calculated by multiplying the market cap of the company by an investable weight factor for the company and by the quotient resulting from dividing the CEI score by 100, as shown in the equation below:

$${Shares}_{m} = Market {Cap}_{m} \times I W {F}_{m} \times ( \frac{C E {I}_{m}}{100} )$$

where Sharesₘ is the number of shares of stock for each company m included in the SI index, Market Capₘ is the market capitalization for the company m, IWFₘ is an investable weight factor for the company m, and CEIₘ is the CEI score for company m, as outlined Corporate Equality Index (CEI) ratings published by the Human Rights Campaign Foundation.

In one implementation of the LGBT Equality Index, the weight given to each security in the index is determined by multiplying the underlying company's float-adjusted market cap by the company's CEI score. So a company with a market cap of $10 million, a float of 0.9, and a score of 100 in the CEI would have $10 million*0.9*1.0=9 million shares on the LGBT Equality Index. The weight of the company on the index would then be 9 million divided by the cumulative market shares of the index.

The LGBT Equality Index may also be reconstituted or rebalanced periodically. In one implementation, there is a single reconstitution of the index on a predetermined date, for example on the third Friday in December, to reflect the new CEI scores, which are typically released once a year in the Fall. The LGBT Equality Index may also be rebalanced quarterly, for example on the third Friday of each quarter-ending month (March, June, and September) to account for shares outstanding, float changes, or to adjust for CEI score updates that occur between rebalance dates. In one implementation, the rebalance date may be released after the market closes on the Friday before the rebalance date.

In one implementation, the sponsoring institution for the LGBT Equality Index may send new weights calculated on the rebalancing date to S&P or any other suitable service provider on or before the Friday before the announcement (two Fridays before the rebalance).

In one implementation, the universe of S&P 1500 stocks will be the pro form a universe used as a prerequisite to inclusion in the LGBT Equality Index. This pro form a universe of securities may be announced before the rebalance date. In one implementation, the pro form a universe of securities is announced on the Friday before the rebalance date. If that universe changes between the announcement date and the rebalance date, the LGBT Equality Index will use the new S&P universe as the prerequisite for inclusion. That is, there may be changes to the announced rebalance data during the week between the announcement and the rebalance date. If a company drops out of the predetermined universe of securities between rebalances, the LGBT Index may be calculated with one less company, which may require a change in the divisor—the cumulative market shares of the LGBT Equality Index.

### SI Controller

FIG. 5 illustrates inventive aspects of an SI controller 501 in a block diagram. In this embodiment, the SI controller 501 may serve to aggregate, process, store, search, serve, identify, instruct, generate, match, and/or facilitate interactions with a computer through social impact index and associated financial product generation and management technologies, and/or other related data.

Typically, users, which may be people and/or other systems, may engage information technology systems (e.g., computers) to facilitate information processing. In turn, computers employ processors to process information; such processors 503 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 529 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by the CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the SI controller 501 may be connected to and/or communicate with entities such as, but not limited to: one or more users from user input devices 511; peripheral devices 512; an optional cryptographic processor device 528; and/or a communications network 513.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally understood to be an interconnection of a multitude of networks whereby remote clients and servers may access and interoperate with one another.

The SI controller 501 may be based on computer systems that may comprise, but are not limited to, components such as: a computer systemization 502 connected to memory 529.

### Computer Systemization

A computer systemization 502 may comprise a clock 530, central processing unit (“CPU(s)” and/or “processor(s)” (these terms are used interchangeable throughout the disclosure unless noted to the contrary)) 503, a memory 529 (e.g., a read only memory (ROM) 506, a random access memory (RAM) 505, etc.), and/or an interface bus 507, and most frequently, although not necessarily, are all interconnected and/or communicating through a system bus 504 on one or more (mother)board(s) 502 having conductive and/or otherwise transportive circuit pathways through which instructions (e.g., binary encoded signals) may travel to effect communications, operations, storage, etc. Optionally, the computer systemization may be connected to an internal power source 586. Optionally, a cryptographic processor 526 may be connected to the system bus. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 529 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the SI controller and beyond through various interfaces. Should processing requirements dictate a greater amount speed and/or capacity, distributed processors (e.g., Distributed SI), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the SI may be achieved by implementing a microcontroller such as CAST's R8051XC2 microcontroller; Intel's MCS 51 (i.e., 8051 microcontroller); and/or the like. Also, to implement certain features of the SI, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the SI component collection (distributed or otherwise) and/or features may be implemented via the microprocessor and/or via embedded components; e.g., via ASIC, coprocessor, DSP, FPGA, and/or the like. Alternately, some implementations of the SI may be implemented with embedded components that are configured and used to achieve a variety of features or signal processing.

Depending on the particular implementation, the embedded components may include software solutions, hardware solutions, and/or some combination of both hardware/software solutions. For example, SI features discussed herein may be achieved through implementing FPGAs, which are a semiconductor devices containing programmable logic components called “logic blocks,” and programmable interconnects, such as the high performance FPGA Virtex series and/or the low cost Spartan series manufactured by Xilinx. Logic blocks and interconnects can be programmed by the customer or designer, after the FPGA is manufactured, to implement any of the SI features. A hierarchy of programmable interconnects allow logic blocks to be interconnected as needed by the SI system designer/administrator, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the SI may be developed on regular FPGAs and then migrated into a fixed version that more resembles ASIC implementations. Alternate or coordinating implementations may migrate SI controller features to a final ASIC instead of or in addition to FPGAs. Depending on the implementation all of the aforementioned embedded components and microprocessors may be considered the “CPU” and/or “processor” for the SI.

### Power Source

The power source 586 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 586 is connected to at least one of the interconnected subsequent components of the SI thereby providing an electric current to all subsequent components. In one example, the power source 586 is connected to the system bus component 504. In an alternative embodiment, an outside power source 586 is provided through a connection across the I/O 508 interface. For example, a USB and/or IEEE 1394 connection carries both data and power across the connection and is therefore a suitable source of power.

### Interface Adapters

Interface bus(ses) 507 may accept, connect, and/or communicate to a number of interface adapters, conventionally although not necessarily in the form of adapter cards, such as but not limited to: input output interfaces (I/O) 508, storage interfaces 509, network interfaces 510, and/or the like. Optionally, cryptographic processor interfaces 527 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 509 may accept, communicate, and/or connect to a number of storage devices such as, but not limited to: storage devices 514, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 510 may accept, communicate, and/or connect to a communications network 513. Through a communications network 513, the SI controller is accessible through remote clients 533b (e.g., computers with web browsers) by users 533a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed SI), architectures may similarly be employed to pool, load balance, and/or otherwise increase the communicative bandwidth required by the SI controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 510 may be used to engage with various communications network types 513. For example, multiple network interfaces may be employed to allow for the communication over broadcast, multicast, and/or unicast networks.

Input Output interfaces (I/O) 508 may accept, communicate, and/or connect to user input devices 511, peripheral devices 512, cryptographic processor devices 528, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless: 802.11a/b/g/n/x, Bluetooth, code division multiple access (CDMA), global system for mobile communications (GSM), WiMax, etc.; and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 511 may be card readers, dongles, finger print readers, gloves, graphics tablets, joysticks, keyboards, mouse (mice), remote controls, retina readers, trackballs, trackpads, touch screens and/or the like.

Peripheral devices 512 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the SI controller may be embodied as an embedded, dedicated, and/or monitor-less (i.e., headless) device, wherein access would be provided over a network interface connection.

Cryptographic units such as, but not limited to, microcontrollers, processors 526, interfaces 527, and/or devices 528 may be attached, and/or communicate with the SI controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 529. However, memory is a fungible technology and resource, thus, any number of memory embodiments may be employed in lieu of or in concert with one another. It is to be understood that the SI controller and/or a computer systemization may employ various forms of memory 529. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 529 will include ROM 506, RAM 505, and a storage device 514. A storage device 514 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 529 may contain a collection of program and/or database components and/or data such as, but not limited to: operating system component(s) 515 (operating system); information server component(s) 516 (information server); user interface component(s) 517 (user interface); Web browser component(s) 518 (Web browser); database(s) 519; mail server component(s) 521; mail client component(s) 522; cryptographic server component(s) 520 (cryptographic server); the SI component(s) 535; and/or the like (i.e., collectively a component collection). These components may be stored and accessed from the storage devices and/or from storage devices accessible through an interface bus. Although non-conventional program components such as those in the component collection, typically, are stored in a local storage device 514, they may also be loaded and/or stored in memory such as: peripheral devices, RAM, remote storage facilities through a communications network, ROM, various forms of memory, and/or the like.

### Operating System

The operating system component 515 is an executable program component facilitating the operation of the SI controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Nan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server)/7/8, Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the SI controller to communicate with other entities through a communications network 513. Various communication protocols may be used by the SI controller as a subcarrier transport mechanism for interaction, such as, but not limited to: multicast, TCP/IP, UDP, unicast, and/or the like.

### Information Server

An information server component 516 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the SI controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the SI database 519, operating systems, other program components, user interfaces, Web browsers, and/or the like.

Access to the SI database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the SI. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the SI as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 517 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 518 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into smartphones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the SI enabled nodes. The combined application may be nugatory on systems employing standard Web browsers.

### Mail Server

A mail server component 521 is a stored program component that is executed by a CPU 503. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP₃), simple mail transfer protocol (SMTP), and/or the like. The mail server can route, forward, and process incoming and outgoing mail messages that have been sent, relayed and/or otherwise traversing through and/or to the SI.

Access to the SI mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 522 is a stored program component that is executed by a CPU 503. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POPS, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 520 is a stored program component that is executed by a CPU 503, cryptographic processor 526, cryptographic processor interface 527, cryptographic processor device 528, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the SI may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the SI component to engage in secure transactions if so desired. The cryptographic component facilitates the secure accessing of resources on the SI and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The SI Database

The SI database component 519 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the SI database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the SI database is implemented as a data-structure, the use of the SI database 519 may be integrated into another component such as the SI component 535. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 519 includes several tables 519a-c. A market data table 519a may include fields such as, but not limited to: market_data_feed_ID, asset_ID, asset_symbol, asset_name, spot_price, bid_price, ask_price, and/or the like; in one embodiment, the market data table is populated through a market data feed (e.g., Bloomberg's PhatPipe, Dun & Bradstreet, Reuter's Tib, Triarch, etc.), for example, through Microsoft's Active Template Library and Dealing Object Technology's real-time toolkit Rtt.Multi. An indices table 519b may include fields such as, but not limited to: index_ID, index_name, components, values, history, portfolio_ID, portfolio_components, portfolio_weights, portfolio_values, product_ID(s), restrictions and/or authorizations, index_profile, impact_metric, and/or the like. A products table 519c may include fields such as, but not limited to: product_ID, product_name, index_ID(s), terms, restrictions, transaction_history, values, chain_of_title, and/or the like.

In one embodiment, the SI database may interact with other database systems. For example, employing a distributed database system, queries and data access by search SI component may treat the combination of the SI database, an integrated data security layer database as a single database entity.

In one embodiment, user programs may contain various user interface primitives, which may serve to update the SI. Also, various accounts may require custom database tables depending upon the environments and the types of clients the SI may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 519a-c. The SI may be configured to keep track of various settings, inputs, and parameters via database controllers.

The SI database may communicate to and/or with other components in a component collection, including itself, and/or facilities of the like. Most frequently, the SI database communicates with the SI component, other program components, and/or the like. The database may contain, retain, and provide information regarding other nodes and data.

### The SIs

The SI component 535 is a stored program component that is executed by a CPU. In one embodiment, the SI component incorporates any and/or all combinations of the aspects of the SI that was discussed in the previous figures. As such, the SI affects accessing, obtaining and the provision of information, services, transactions, and/or the like across various communications networks.

The SI component enables the determination of weights for constituents of index-linked financial portfolios, the acquisition and/or maintenance/management of those constituents, the determination of market values and/or returns associated with the indices, the generation of financial products based on the indices, and/or the like and use of the SI.

The SI component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the SI server employs a cryptographic server to encrypt and decrypt communications. The SI component may communicate to and/or with other components in a component collection, including itself, and/or facilities of the like. Most frequently, the SI component communicates with the SI database, operating systems, other program components, and/or the like. The SI may contain, communicate, generate, obtain, and/or provide program component, system, user, and/or data communications, requests, and/or responses.

### Distributed SIs

The structure and/or operation of any of the SI node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the SI controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), local and remote application program interfaces Jini, Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., the SOAP parser) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment. The following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=/
com.ibm.IBMDI.doc/referenceguide295.htm

and other parser implementations:

http://publib.boulder.ibm.com/infocenter/tivihelp/v2r1/index.jsp?topic=/
com.ibm.IBMDI.doc/referenceguide295.htm

all of which are hereby expressly incorporated by reference.

To address various issues related to, and improve upon, previous work, the application is directed to SOCIAL IMPACT INVESTMENT INDEX APPARATUSES, METHODS, AND SYSTEMS. The entirety of this application (including the Cover Page, Title, Headings, Field, Background, Summary, Brief Description of the Drawings, Detailed Description, Claims, Abstract, Figures, Appendices, and any other portion of the application) shows by way of illustration various embodiments. The advantages and features disclosed are representative; they are not exhaustive or exclusive. They are presented only to assist in understanding and teaching the claimed principles. It should be understood that they are not representative of all claimed inventions. As such, certain aspects of the invention have not been discussed herein. That alternate embodiments may not have been presented for a specific portion of the invention or that further undescribed alternate embodiments may be available for a portion of the invention is not a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the invention. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions in additional applications, continuations, continuations in part, divisions, and the like. As such, it should be understood that advantages, embodiments, examples, functionality, features, logical aspects, organizational aspects, structural aspects, topological aspects, and other aspects of the disclosure are not to be considered limitations on the disclosure as defined by the claims or limitations on equivalents to the claims.

Depending on the particular needs and/or characteristics of an SI user, index underlying assets, financial product issuer, applicable market, market data source(s), index configuration, financial advisor, individual and/or enterprise user, database configuration and/or relational model, data type, data transmission and/or network framework, syntax structure, and/or the like, various embodiments of the SI may be implemented that enable a great deal of flexibility and customization. This disclosure discusses embodiments and/or applications of the SI directed to generating, managing, administrating and disseminating social impact investing indices (e.g., based on a financial index such as the S&P 1500), their underlying portfolios and/or associated financial products. However, it is to be understood that the apparatuses, methods and systems discussed herein may be readily adapted and/or reconfigured for a wide variety of other applications and/or implementations. Furthermore, aspects of the SI may be configured to generate, administer, and/or manage a wide variety of different financial instruments, securities, and/or the like beyond specific embodiments and/or implementations described in detail herein. For example, indices discussed herein may underlie and/or be linked to any of a wide variety of financial products, derivatives, instruments, and/or the like, such as but not limited to: equities, debts, derivatives, notes (e.g., structured notes), stocks, preferred shares, bonds, treasuries, debentures, options, futures, swaps, rights, warrants, commodities, currencies, funds, long and/or short positions, ETFs, ETNs, insurance and/or risk transfer agreements, annuities, and/or other assets or investment interests. The SI may be further adapted to other implementations and/or investment, finance and/or risk management applications.

1. A processor-implemented method for calculating an investable index, the method comprising:
determining, using a processor, a non-financial impact metric associated with each company included in a predetermined group of publicly traded companies;
comparing, using the processor, the non-financial impact metric for each company to a predetermined threshold;
creating, using the processor, a notional portfolio that includes only the companies in the predetermined group whose non-financial metric meets the predetermined threshold; and
calculating an index value, using the processor, based on at least a publicly available share price and the non-financial impact metric, for each company in the notional portfolio.

2. The method of claim 1, wherein calculating the index value further comprises, for each company in the notional portfolio, multiplying a notional number of shares of the company by publicly available share price of the company to calculate a first product, dividing the product by a divisor to calculate a result, and summing the result calculated for each company with the result calculated for each of the other companies in the notional portfolio.

3. The method of claim 2, further comprising calculating the notional number of shares of the company by multiplying an initial index value by the quotient of a weight for the company and the publicly available share price for the company.

4. The method of claim 1, wherein calculating the index value comprises determining the number of shares to be included in the index for each company in the notional portfolio by multiplying the market capitalization of the company by the non-financial impact metric.

5. The method of claim 4, wherein calculating the index value further comprises multiplying the product of the market capitalization of the company and the non-financial impact metric with an investable weight factor.

6. The method of claim 1, further comprising periodically rebalancing the notional portfolio and recalculating the index value.

7. The method of claim 1, further comprising periodically reconstituting the notional portfolio based on updated data relating to the non-financial impact metric for each company.

8. The method of claim 1, further comprising periodically publishing the index value.

9. The method of claim 1, wherein the predetermined group of publicly traded companies comprises the companies included in at least one of the S&P 1500, the S&P 500, the S&P Midcap, the S&P Smallcap, the Nasdaq, and the New York Stock Exchange.

10. The method of claim 1, wherein the non-financial impact metric relates to at least one of a company's mission, operational model, policies, and performance in relation to a predetermined issue.

11. The method of claim 1, wherein the predetermined issues is at least one of healthcare, education, sustainability, equality, health, and environmental impact.

12. The method of claim 1, wherein the non-financial impact metric comprises an equality index score derived from the policies and practices of each company in relation to Lesbian, Gay, Bisexual, and Transgender (LGBT) rights.

13. The method of claim 1, wherein the non-financial impact metric comprises a Corporate Equality Index Score published by the Human Rights Campaign Foundation.

14. A system for calculating an investable index that includes a non-financial impact metric component, the system comprising:
a server having a processor and a memory and being programmable to interface with a database;
an index calculator interfacing with the server and being programmable to:
determine a non-financial impact metric associated with each company included in a predetermined group of publicly traded companies;
compare each one of the non-financial impact metrics to a predetermined threshold;
create a notional portfolio that includes only the companies in the predetermined group whose non-financial metric meets the predetermined threshold; and
calculate an index value based on at least a publicly available share price and the non-financial impact metric, for each company in the notional portfolio.

15. The system of claim 14, wherein the index calculator is further programmable to calculate the index value by, for each company in the notional portfolio, multiplying a notional number of shares of the company by the price of a share of the company to calculating a first product, dividing the product by a divisor to calculate a result, and summing the result calculated for each company with the result calculated for each of the other companies in the notional portfolio.

16. The system of claim 15, wherein the index calculator is further programmable to calculate the notional number of shares of the company by multiplying an initial index value by the quotient of a weight for the company and the publicly available share price for the company.

17. The system of claim 14, wherein the index calculator is further programmable to determine the number of shares to be included in the index for each company in the notional portfolio by multiplying the market capitalization of the company and the non-financial impact metric associated with the company.

18. The system of claim 17, wherein the index calculator is further programmable to multiply the product of the market capitalization of the company and the non-financial impact metric with an investable weight factor.

19. A processor-implemented method for generating a financial instrument, the method comprising:
generating, using the processor, at least one financial instrument having an instrument value that depends on an index value for an index that includes a non-financial impact metric component;
wherein the index value is calculated by
determining, using a processor, a non-financial impact metric associated with each company included in a predetermined group of publicly traded companies;
comparing, using the processor, each one of the non-financial impact metrics to a predetermined threshold;
creating, using the processor, a notional portfolio that includes only the companies in the predetermined group whose non-financial impact metric meets the predetermined threshold; and
calculating an index value, using the processor, based on at least a publicly available share price and the non-financial impact metric, for each company in the notional portfolio.

20. The method of claim 19, wherein the financial instrument is at least one of a mutual fund, an exchange traded fund, an exchange traded note, an option contract, a futures contract, and a swap.

21. A processor-implemented method for calculating a Lesbian, Gay, Bisexual, and Transgender (LGBT) equality index, the method comprising:
determining, using a processor, an LGBT equality score for each company included in a predetermined group of publicly traded companies, wherein the equality score is derived from the policies and practices of the company in relation to LGBT rights;
comparing, using the processor, the LGBT equality score for each company to a predetermined threshold;
creating, using the processor, a notional portfolio that includes only the companies in the predetermined group whose LGBT equality score meet the predetermined threshold; and
calculating an LGBT equality index value, using the processor, based on at least a share price and the LGBT equality score, for each company in the notional portfolio.

22. The method of claim 21, wherein the LGBT equality score comprises a Corporate Equality Index Score published by the Human Rights Campaign Foundation.

23. The method of claim 22, wherein calculating an LGBT equality index value comprises calculating the number of shares for each company to be in included in the LGBT equality index by multiplying the market cap of the company by an investable weight factor for the company and by the quotient resulting from dividing the CEI score by 100.
